(19) United States
(12) Patent Application Publication
(10) Pub. No.: US 2025/0180965 A1
(43) Pub. Date: Jun. 5, 2025

(54) LENS HOLDER DRIVING DEVICE

(71) Applicant: ALPS ALPINE CO., LTD., Tokyo (JP)

(72) Inventors: Katsutoshi SUZUKI, Tokyo (JP); Takeshi MURAYAMA, Jiangsu (CN); Takuya KATO, Miyagi (JP)

(21) Appl. No.: 19/042,423

(22) Filed: Jan. 31, 2025

Related U.S. Application Data
(63) Continuation of application No. PCT/JP2023/008525, filed on Mar. 7, 2023.

(30) Foreign Application Priority Data
Aug. 10, 2022 (JP) 2022-128149

(51) Int. Cl. G03B 13/34; G02B 7/10; G03B 5/00

(52) U.S. Cl. CPC G03B 13/34; G02B 7/10; G03B 5/00; G03B 2205/0061

(57) ABSTRACT

A lens holder driving device includes a fixed-side member; a first lens holder configured to hold a first lens body; a second lens holder configured to hold a second lens body; a first movable-side member including the first lens holder; a second movable-side member including the second lens holder; a first piezoelectric driver that moves the first lens holder in an optical axis direction by a motion of a first piezoelectric device; and a second piezoelectric driver that moves the second lens holder in the optical axis direction by a motion of a second piezoelectric device. The second movable-side member is included in the first movable-side member and is movable in the optical axis direction with respect to the first lens holder. The first piezoelectric driver is provided in the fixed-side member, and the second piezoelectric driver is provided in the second movable-side member.

### CROSS-REFERENCE TO RELATED APPLICATIONS

This application is a continuation application of International Application No. PCT/JP2023/008525 filed on Mar. 7, 2023, and designated the U.S., which is based upon and claims priority to Japanese Patent Application No. 2022-128149 filed on Aug. 10, 2022, the entire contents of which are incorporated herein by reference.

### BACKGROUND

### 1. Technical Field The present disclosure relates to a lens holder driving device.

### 2. Description of Related Art

Conventionally, a lens driving device is known which can separately move a first movable portion holding a first movable lens and a second movable portion holding a second movable lens in an optical axis direction (see Japanese Unexamined Patent Publication No. 2021-105653, hereinafter “Patent Document 1”).

### SUMMARY

A lens holder driving device according to an embodiment of the present invention includes: a fixed-side member; a first lens holder configured to hold a first lens body; a second lens holder configured to hold a second lens body arranged in such a manner that the second lens body has a same optical axis as the first lens body; a first movable-side member including the first lens holder; a second movable-side member including the second lens holder; a first piezoelectric driver configured to include a first piezoelectric device and move the first movable-side member in a direction of the optical axis by a motion of the first piezoelectric device; and a second piezoelectric driver configured to include a second piezoelectric device and move the second movable-side member in the direction of the optical axis by a motion of the second piezoelectric device. The second movable-side member is included in the first movable-side member and is movable in the direction of the optical axis with respect to the first lens holder. The first piezoelectric driver is provided in the fixed-side member or the first lens holder, and the second piezoelectric driver is provided in the second movable-side member or the first lens holder.

### BRIEF DESCRIPTION OF THE DRAWINGS

FIG. 1A is a perspective view of a lens holder driving device;

FIG. 1B is an exploded perspective view of the lens holder driving device;

FIG. 2 is a schematic diagram of a camera module;

FIG. 3 is an exploded perspective view of the lens holder driving device in a state where a cover member is removed;

FIG. 4 is an exploded perspective view of a first movable-side member;

FIG. 5A is a perspective view of the first movable-side member supported by a shaft member;

FIG. 5B is a perspective view of a first lens holder driven by a first piezoelectric driver; FIG. 5C is a perspective view of a second lens holder driven by a second piezoelectric driver; FIG. 6A is a perspective view of a piezoelectric driver pressed against the shaft member by a biasing member;

FIG. 6B is an exploded perspective view of the biasing member and the piezoelectric driver;

FIG. 7 is a perspective view of a first biasing member attached to a base member;

FIG. 8 is a front view of a lens holder; and

FIG. 9 is a diagram illustrating an example of a positional relationship between a magnetic sensor, a magnetic field generating member, and a circuit board.

### DETAILED DESCRIPTION

Since the aforementioned lens driving device has, for example, a configuration in which the first movable lens (a zoom lens) and the second movable lens (a focus lens) move separately in the optical axis direction, there is a concern that the time required for focusing may be long at the time of zooming-in or zooming-out.

Therefore, it is desired to provide a lens holder driving device capable of moving two lens holders more efficiently.

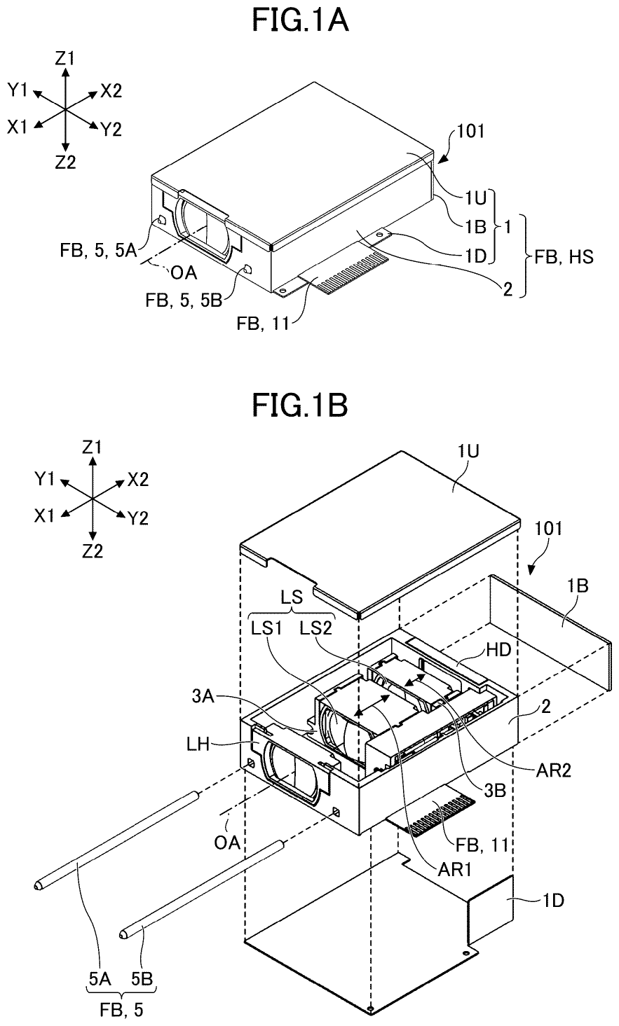

Hereinafter, a lens holder driving device 101 according to an embodiment of the present invention will be described with reference to the drawings. FIG. 1A is a perspective view of the lens holder driving device 101.

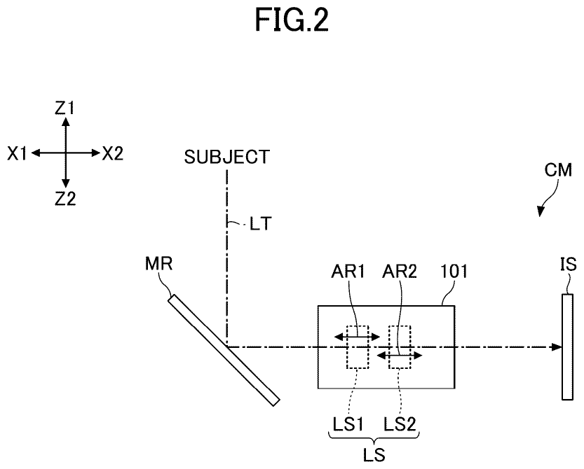

FIG. 1B is an exploded perspective view of the lens holder driving device 101. FIG. 2 is a schematic diagram of a camera module CM in a camera-equipped portable device in which the lens holder driving device 101 is implemented.

In the illustrated example, X1 represents one direction of the X-axis included in the three-dimensional orthogonal coordinate system, and X2 represents the other direction of the X-axis. Y1 represents one direction of the Y-axis included in the three-dimensional orthogonal coordinate system, and Y2 represents the other direction of the Y-axis. Z1 represents one direction of the Z-axis included in the three-dimensional orthogonal coordinate system, and Z2 represents the other direction of the Z-axis. The X1 side of the lens holder driving device 101 corresponds to the front side (subject side) of the lens holder driving device 101, and the X2 side of the lens holder driving device 101 corresponds to the rear side (image sensor side) of the lens holder driving device 101. The Y1 side of the lens holder driving device 101 corresponds to the left side of the lens holder driving device 101, and the Y2 side of the lens holder driving device 101 corresponds to the right side of the lens holder driving device 101. The Z1 side of the lens holder driving device 101 corresponds to the upper side of the lens holder driving device 101, and the Z2 side of the lens holder driving device 101 corresponds to the lower side of the lens holder driving device 101. The same applies to the other drawings.

The lens holder driving device 101 is configured to be able to move a lens body LS along an optical axis OA of the lens body LS.

The lens body LS is an example of an optical member, and is configured by one or a plurality of lenses. Typically, the lens body LS is a cylindrical lens barrel including at least one lens, and is configured in such a manner that the central axis thereof is along the optical axis OA. In the illustrated example, the lens body LS includes a first lens body LS1 including a zoom lens and a second lens body LS2 including a focus lens.

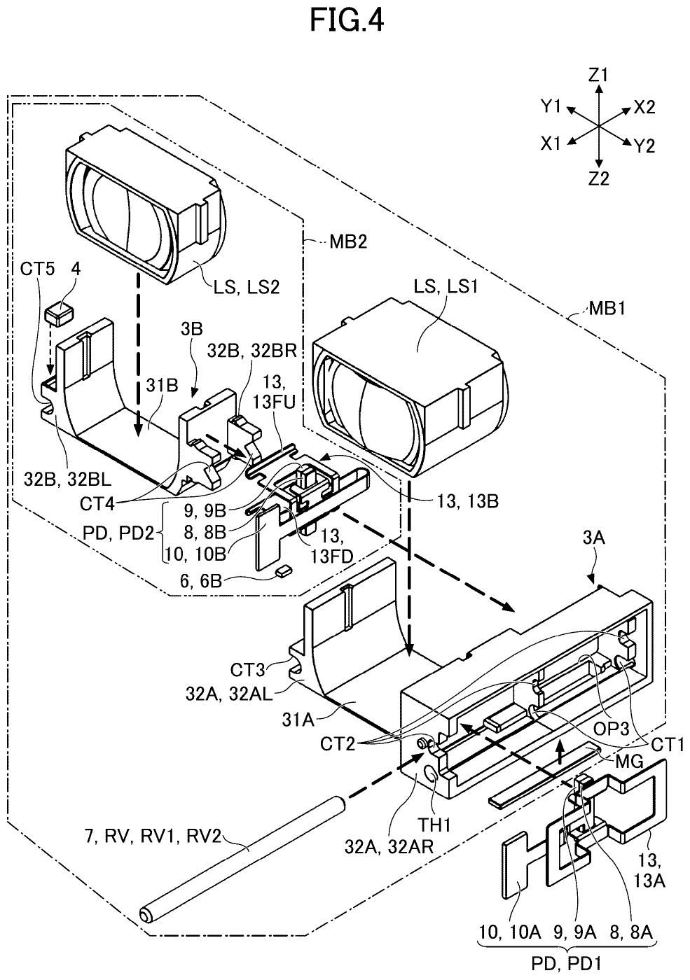

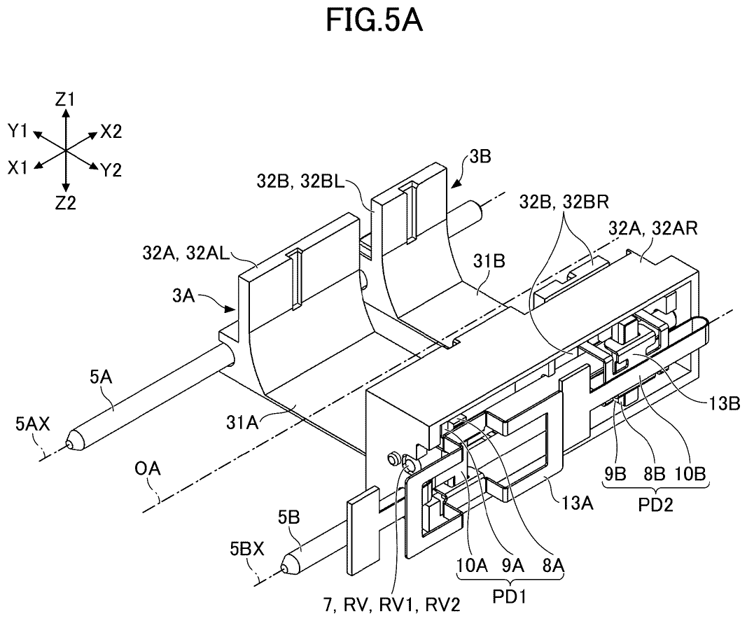

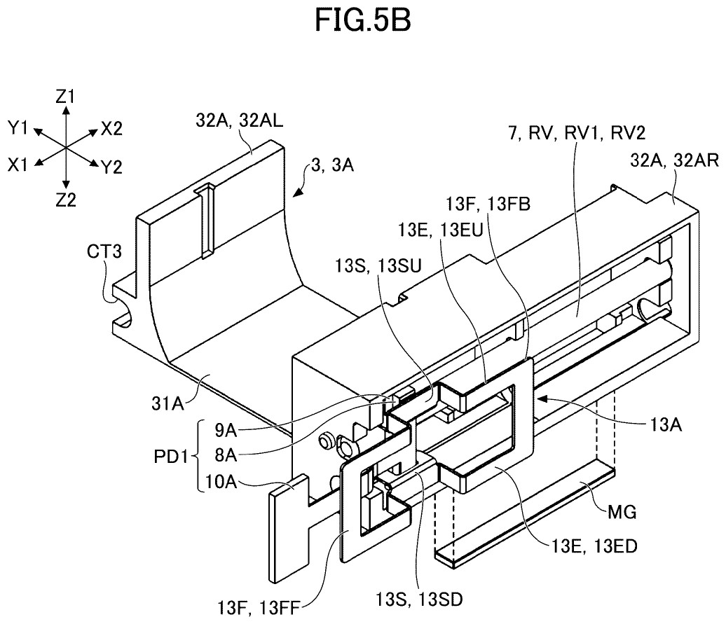

The lens holder driving device 101 is configured to be able to move the lens body LS along an optical axis direction using a piezoelectric driver PD (see FIG. 4) stored in a housing HS. The optical axis direction includes the direction of the optical axis OA of the lens body LS and a direction parallel to the optical axis OA. Specifically, the lens holder driving device 101 can move the first lens body LS1 along the optical axis direction as illustrated by double-headed arrow AR1 in each of FIG. 1B and FIG. 2, and can move the second lens body LS2 along the optical axis direction as illustrated by double-headed arrow AR2. In other words, the lens holder driving device 101 can simultaneously move the first lens body LS1 and the second lens body LS2 along the optical axis direction, and can move the second lens body LS2 with respect to the first lens body LS1 along the optical axis direction. The optical axis of the first lens body LS1 and the optical axis of the second lens body LS2 are located on the same line (on the optical axis OA).

As illustrated in FIG. 1A, the housing HS is a part of the fixed-side member FB, and includes a cover member 1 and a base member 2. As illustrated in FIG. 1B, the cover member 1 includes an upper cover member 1U, a rear cover member 1B, and a lower cover member 1D.

The cover member 1 is configured to cover part of the base member 2. In the illustrated example, the upper cover member 1U and the lower cover member 1D are formed of metals. However, the upper cover member 1U and the lower cover member 1D may be formed of a synthetic resin. The rear cover member 1B is a printed board on which the image sensor IS is mounted.

As illustrated in FIG. 2, the lens holder driving device 101 is used in a camera module CM, such as a periscope camera module. In the example illustrated in FIG. 2, the camera module CM mainly includes a mirror MR, a lens body LS, a lens holder driving device 101, an image sensor IS, and the like. The mirror MR may be a prism. In the example illustrated in FIG. 2, the mirror MR is configured to provide a flat reflective surface.

Typically, as illustrated in FIG. 2, the lens holder driving device 101 is arranged at a position farther from a subject than the mirror MR, and is configured to allow light LT from the subject reflected by the mirror MR to reach the image sensor IS through the lens body LS.

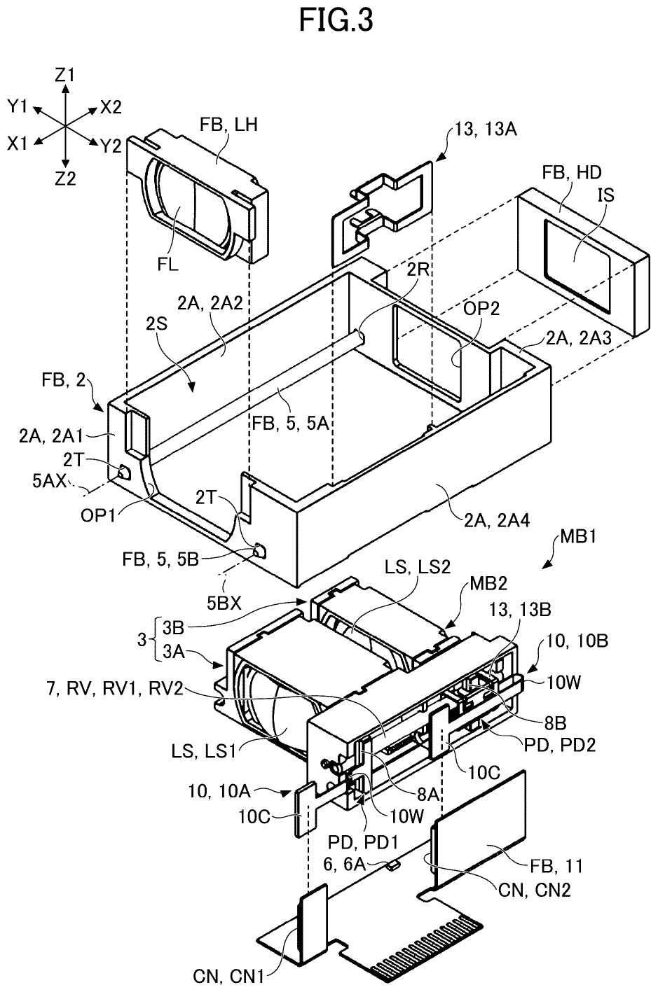

Next, an internal configuration of the lens holder driving device 101 is described with reference to FIG. 3. FIG. 3 is an exploded perspective view of the lens holder driving device 101 in a state where the cover member 1 is removed. Specifically, FIG. 3 is a perspective view of the base member 2, a shaft member 5, an outer circuit board 11, a biasing member 13, an image sensor holder HD, a fixed lens holder LH, a first movable-side member MB1, and the piezoelectric driver PD.

The base member 2 is a member included in a part of the housing HS. In the illustrated example, the base member 2 is formed of a synthetic resin, but may be formed of a metal.

Specifically, the base member 2 has a substantially rectangular cylindrical outer wall portion 2A defining an accommodation portion 2S. The outer wall portion 2A includes a first side plate portion 2A1 through a fourth side plate portion 2A4. The first side plate portion 2A1 and the third side plate portion 2A3 face each other, and the second side plate portion 2A2 and the fourth side plate portion 2A4 face each other. The second side plate portion 2A2 and the fourth side plate portion 2A4 extend perpendicularly to the first side plate portion 2A1 and the third side plate portion 2A3. In other words, the first side plate portion 2A1 and the third side plate portion 2A3 extend perpendicularly to the second side plate portion 2A2 and the fourth side plate portion 2A4. The first side plate portion 2A1 has a first opening OP1 for receiving light LT from the subject reflected by the mirror MR. Similarly, the third side plate portion 2A3 has a second opening OP2 for allowing the light LT to reach the image sensor IS. The cover member 1 is bonded to the base member 2 by an adhesive or the like and thereby forms the housing HS with the base member 2.

As illustrated in FIG. 3, a first biasing member 13A, the image sensor holder HD configured to hold the image sensor IS, and the fixed lens holder LH configured to hold a fixed lens FL are attached to the base member 2. The fixed lens FL is also referred to as a “front lens”. The fixed lens holder LH is attached to the first opening OP1, and the image sensor holder HD is attached to the outside of the second opening OP2. The first movable-side member MB1 and the outer circuit board 11 are accommodated in the accommodation portion 2S of the base member 2.

The shaft member 5 includes a first shaft member 5A having an axial line (a first axis 5AX) parallel to the optical axis OA and a second shaft member 5B having an axial line (a second axis 5BX) parallel to the optical axis OA. Therefore, the first shaft member 5A and the second shaft member 5B extend in the optical axis direction parallel to each other. In the illustrated example, the shaft member 5 is configured in such a manner that one end thereof is inserted into a through hole 2T (see FIG. 3) formed in the first side plate portion 2A1 of the base member 2, and the other end thereof is fitted into a recessed portion 2R formed in the inner surface of the third side plate portion 2A3 of the base member 2. The shaft member 5 may be configured in such a manner that one end thereof is fitted into a recess formed in the inner surface of the first side plate portion 2A1 of the base member 2 and the other end thereof is inserted into a through hole formed in the third side plate portion 2A3 of the base member 2. The shaft member 5 may be fixed to the base member 2 (the first side plate portion 2A1 and the third side plate portion 2A3) with an adhesive. The first shaft member 5A and the second shaft member 5B may be formed of a magnetic metal.

The piezoelectric driver PD is configured to be able to move the lens holder 3 in the optical axis direction with respect to the base member 2 using a supply of electric power. In the illustrated example, the piezoelectric driver PD includes a first piezoelectric driver PD1 that moves the first movable-side member MB1 in the optical axis direction with respect to the base member 2, and a second piezoelectric driver PD2 that moves a second movable-side member MB2 in the optical axis direction with respect to a first lens holder 3A. Specifically, the piezoelectric driver PD is configured to operate in accordance with an applied voltage (a voltage applied to a piezoelectric device 8) controlled by a drive circuit. The drive circuit may be mounted on the outer circuit board 11 or may be arranged outside the housing HS. In the illustrated example, the drive circuit is arranged outside the housing HS.

The first movable-side member MB1 includes the first lens holder 3A, a movable-side shaft member 7, the first lens body LS1, and the second movable-side member MB2. The second movable-side member MB2 is a part of the first movable-side member MB1. Specifically, the second movable-side member MB2 includes a second lens holder 3B, a second lens body LS2, and a second biasing member 13B. The first movable-side member MB1 is configured to be moved in the optical axis direction by the first piezoelectric driver PD1 while being guided by the first shaft member 5A and the second shaft member 5B. The second movable-side member MB2 is configured to be moved in the optical axis direction by the second piezoelectric driver PD2 while being guided by the first shaft member 5A.

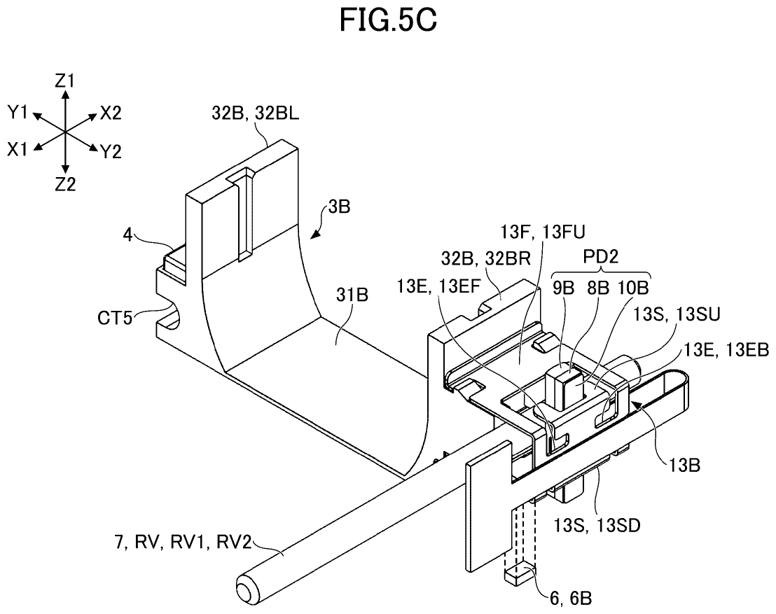

Herein, the first movable-side member MB1 is described in detail with reference to FIGS. 4 and 5A through 5C. FIG. 4 is an exploded perspective view of the first movable-side member MB1. In FIG. 4, for the sake of clarity, how a member is assembled to another member is indicated by a broken-line arrow. In FIG. 4, the members constituting the first movable-side member MB1 are surrounded by a dot-chain line, and the members constituting the second movable-side member MB2 are surrounded by a double dot-chain line. FIG. 5A is a perspective view of the first movable-side member MB1 supported by the shaft member 5. FIG. 5B is a perspective view of the first lens holder 3A driven by the first piezoelectric driver PD1. FIG. 5C is a perspective view of the second lens holder 3B driven by the second piezoelectric driver PD2.

The first lens holder 3A is a member formed by injection-molding a synthetic resin, such as a liquid crystal polymer (LCP), and as illustrated in FIG. 4, has a first holding portion 31A for holding the first lens body LS1 and a first shaft receiving portion 32A for receiving the shaft members. The first shaft receiving portion 32A includes a first left shaft receiving portion 32AL that receives the first shaft member 5A, and a first right shaft receiving portion 32AR that receives the second shaft member 5B and the movable-side shaft member 7.

The second lens holder 3B is a member formed by injection-molding a synthetic resin, such as a liquid crystal polymer (LCP), and as illustrated in FIG. 4, has a second holding portion 31B for holding the second lens body LS2 and a second shaft receiving portion 32B for receiving the shaft members. The second shaft receiving portion 32B includes a second left shaft receiving portion 32BL that receives the first shaft member 5A, and a second right shaft receiving portion 32BR that receives the movable-side shaft member 7.

More specifically, the first right shaft receiving portion 32AR has a first through hole TH1 and two first cutout grooves CT1 each having a substantially semicircular shape opening rightward (in the Y2 direction) and all of which are capable of receiving the second shaft member 5B, and three second cutout grooves CT2 each having a substantially semicircular shape opening rightward (in the Y2 direction) and capable of receiving the movable-side shaft member 7. The first left shaft receiving portion 32AL has a substantially semicircular third cutout groove CT3 which is open leftward (in the Y1 direction) and capable of receiving the first shaft member 5A. The second right shaft receiving portion 32BR has two fourth cutout grooves CT4 each having a substantially V shape opening rightward (in the Y2 direction) and capable of receiving the movable-side shaft member 7. The second left shaft receiving portion 32BL has a substantially semicircular fifth cutout groove CT5 which is open leftward (in the Y1 direction) and capable of receiving the first shaft member 5A.

A magnet 4 is attached to the second left shaft receiving portion 32BL of the second lens holder 3B. The magnet 4 is a member arranged to suppress looseness of the second lens holder 3B in the first shaft member 5A.

The magnet 4 is configured to be able to press a part of the second left shaft receiving portion 32BL of the second lens holder 3B against the upper surface of the first shaft member 5A from above by utilizing a magnetic attraction force acting between the magnet 4 and the first shaft member 5A.

As illustrated in FIG. 5A, at least a part of the second right shaft receiving portion 32BR of the second lens holder 3B is arranged in a space formed in the first right shaft receiving portion 32AR of the first lens holder 3A. Therefore, the first right shaft receiving portion 32AR is provided with a third opening OP3 (see FIG. 4) penetrating in the Y-axis direction.

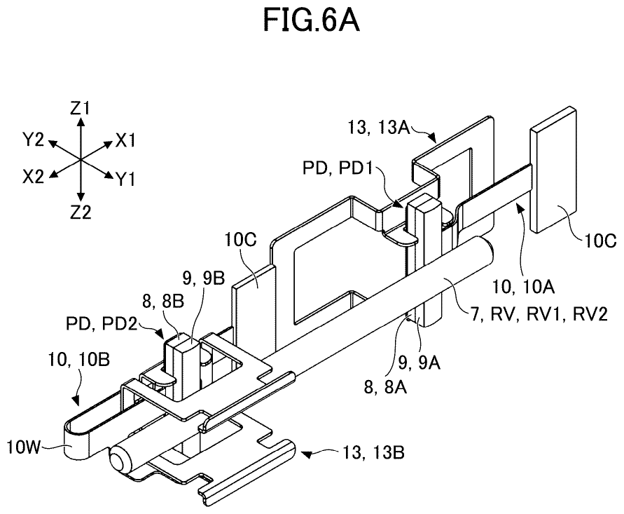

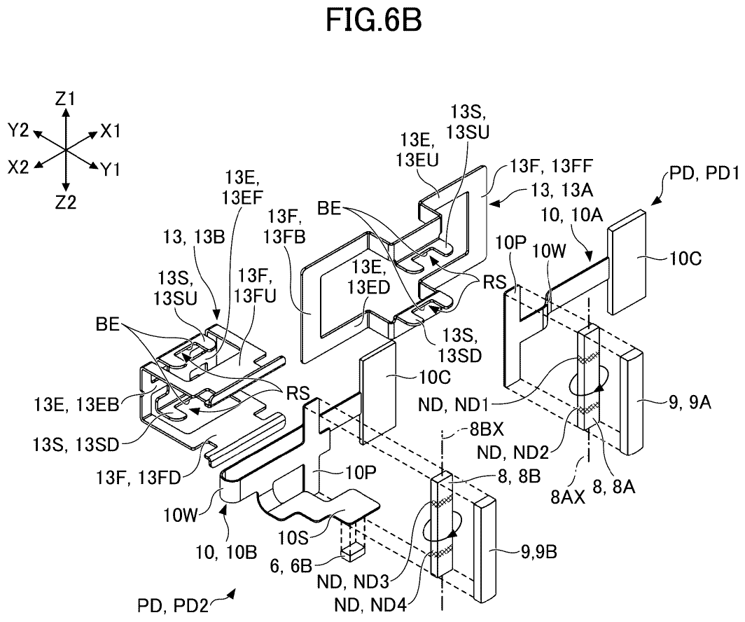

Next, the piezoelectric driver PD will be described with reference to FIGS. 6A and 6B. FIG. 6A is a perspective view of the piezoelectric driver PD pressed against the movable-side shaft member 7 by the biasing member 13, and FIG. 6B is an exploded perspective view of the biasing member 13 and the piezoelectric driver PD.

The piezoelectric driver PD is configured to be able to move the lens holder 3 along the optical axis direction. In the present embodiment, the piezoelectric driver PD is an example of a friction driver using the drive system disclosed in U.S. Pat. No. 7,786,648, and includes a piezoelectric device 8, a contact member 9, and a circuit board 10.

The piezoelectric driver PD is configured to be biased inward (in a direction approaching the optical axis OA) by the biasing member 13 and pressed against the movable-side shaft member 7 serving as the receiving member RV. In the illustrated example, the biasing member 13 for pressing the piezoelectric driver PD against the receiving member RV is formed of a metallic plate and is configured to be in contact with the circuit board 10 attached to the outer side (the side far from the optical axis OA) of the piezoelectric device 8 at portions (inner edge portions BE) corresponding to two nodes ND (see FIG. 6B) formed during bending vibration (circular motion, which is described later) of the piezoelectric device 8. The bonding between the biasing member 13 and the piezoelectric driver PD is realized by, for example, an adhesive.

Specifically, the piezoelectric driver PD includes a first piezoelectric driver PD1 that moves the first lens holder 3A along the optical axis direction with respect to the base member 2, and a second piezoelectric driver PD2 that moves the second lens holder 3B along the optical axis direction with respect to the first lens holder 3A. The first piezoelectric driver PD1 includes a first piezoelectric device 8A, a first contact member 9A, and a first circuit board 10A, and the second piezoelectric driver PD2 includes a second piezoelectric device 8B, a second contact member 9B, and a second circuit board 10B.

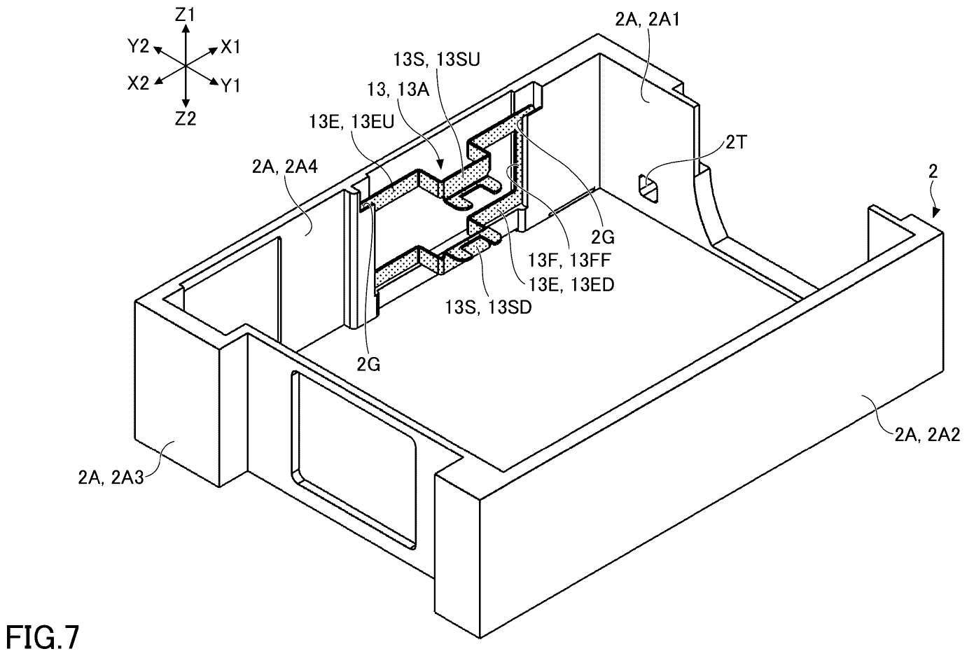

The biasing member 13 includes a first biasing member 13A and a second biasing member 13B. The first biasing member 13A is attached to the base member 2 as illustrated in FIGS. 3 and 7, and is configured to be able to press the first piezoelectric driver PD1 against the first receiving member RV1. The second biasing member 13B is attached to the second lens holder 3B as illustrated in FIG. 4, and is configured to be able to press the second piezoelectric driver PD2 against the second receiving member RV2.

The movable-side shaft member 7 is a shaft member fixed to the first lens holder 3A, and is configured to function as the receiving member RV (the first receiving member RV1 and the second receiving member RV2). The movable-side shaft member 7 is fixed to the three second cutout grooves CT2 provided in the first right shaft receiving portion 32AR of the first lens holder 3A with an adhesive.

As illustrated in FIG. 6B, the first piezoelectric device 8A extends in the Z-axis direction which is a direction (a direction perpendicular to the optical axis OA) orthogonal to the optical axis direction (the X-axis direction), and is configured to be able to realize bending vibration (circular motion) having two nodes ND. In other words, when the bending vibration is performed, the two nodes ND hardly vibrate. Specifically, the first piezoelectric device 8A has a two-layer structure stacked in the Y-axis direction, which is constituted by a first layer that realizes first bending vibration on the XZ plane and a second layer that realizes second bending vibration on the YZ plane. The first piezoelectric driver PD1 can bend and vibrate (circularly move) the first piezoelectric device 8A so that the orbit drawn by the midpoint of the first piezoelectric device 8A becomes a circular orbit around the first rotation axis 8AX in a top view when an application of a voltage to the piezoelectric devices constituting the first layer and an application of a voltage to the piezoelectric devices constituting the second layer are individually performed at appropriate timings. In other words, the first piezoelectric device 8A can realize a motion (circular motion) in which the midpoint thereof draws a circle. In the example illustrated in FIG. 6B, the first rotation axis 8AX is parallel to the Z axis. In addition, the first piezoelectric driver PD1 can switch the movement direction (rotation direction) of the midpoint that follows the circular orbit between the clockwise direction and the counterclockwise direction when viewed from the Z1 side by applying a voltage at an appropriate timing. This switching of the rotation direction allows the first piezoelectric driver PD1 to switch the movement direction of the first lens holder 3A along the optical axis direction. The circle (circular orbit) drawn by the midpoint of the first piezoelectric device 8A is not required to be a perfect circle, and may be a substantially circular shape.

The arrow drawn around the first piezoelectric device 8A in FIG. 6B represents bending vibration of the first piezoelectric device 8A (a circular motion in which the first piezoelectric device 8A rotates in the clockwise direction as viewed from the Z1 side around the first rotation axis 8AX while being bent). In this case, the first movable-side member MB1 including the first receiving member RV1 (the movable-side shaft member 7) in contact with the first contact member 9A of the first piezoelectric driver PD1 moves rearward (in the X2 direction). Although not indicated by an arrow, the first piezoelectric device 8A can also rotate in the counterclockwise direction as viewed from the Z1 side around the first rotation axis 8AX while being bent. In this case, the first movable-side member MB1 including the first receiving member RV1 (the movable-side shaft member 7) in contact with the first contact member 9A of the first piezoelectric driver PD1 moves forward (in the X1 direction).

In other words, the first lens holder 3A to which the first receiving member RV1 (the movable-side shaft member 7) is attached is moved rearward (in the X2 direction) when the rotation direction of the midpoint of the first piezoelectric device 8A is clockwise in a top view, and is moved forward (in the X1 direction) when the rotation direction of the midpoint of the first piezoelectric device 8A is counterclockwise. In the illustrated example, the midpoint of the first piezoelectric device 8A is a point where the first bending vibration has a maximum magnitude (a point corresponding to an antinode of the first bending vibration) and a point where the second bending vibration has a maximum magnitude (a point corresponding to an antinode of the second bending vibration).

The first contact member 9A is attached to the first piezoelectric device 8A and is configured to be in contact with the first receiving member RV1 (the movable-side shaft member 7). In the illustrated example, the first contact member 9A is bonded to the inner surface of the first piezoelectric device 8A with an adhesive so as to cover the entire inner surface (the Y1 side which is a side facing the optical axis OA) of the first piezoelectric device 8A. The first contact member 9A is formed of a metal such as stainless steel, and is configured to have an appropriate thickness so as to be able to perform bending vibration (circular motion) in response to bending vibration (circular motion) of the first piezoelectric device 8A. In the illustrated example, the first contact member 9A is a friction plate formed of stainless steel. The first contact member 9A extends in the Z-axis direction which is the same direction as the direction in which the first piezoelectric device 8A extends. The first contact member 9A is configured in such a manner that the inner surface (the surface on the Y1 side) of a central portion thereof comes into contact with the first receiving member RV1 (the movable-side shaft member 7). Specifically, the first contact member 9A is configured to come into contact with the first receiving member RV1 (the movable-side shaft member 7) at a portion where bending vibration (circular motion) has the maximum magnitude (a portion corresponding to an antinode of the bending vibration). In addition, the first contact member 9A has a surface on a side (the Y1 side) which comes into contact with the first receiving member RV1 (the movable-side shaft member 7), which is a convex curved surface which is convex to the Y1 side.

The movable-side shaft member 7 is typically formed of a metal such as stainless steel. In the illustrated example, the movable-side shaft member 7 is a columnar rod member made of stainless steel and extending in the optical axis direction. As long as the first contact member 9A comes into contact with the movable-side shaft member 7, a length dimension of the first contact member 9A in the Z-axis direction may differ from that of the first piezoelectric device 8A. In the illustrated example, the length dimension of the first contact member 9A in the Z-axis and that of the first piezoelectric device 8A are substantially the same.

The first circuit board 10A is a substrate including a conductive pattern, and is configured to be able to electrically connect an external power source (a drive circuit) and the first piezoelectric device 8A via the outer circuit board 11. In the illustrated example, the first circuit board 10A is a flexible printed substrate having flexibility, and includes a connector portion 10C, a piezoelectric device fixing portion 10P, and a curved portion 10W.

The outer circuit board 11 (see FIG. 3) is a substrate including a conductive pattern, and is configured to be able to electrically connect an external power supply and the circuit board 10 (the first circuit board 10A and the second circuit board 10B). In the illustrated example, the outer circuit board 11 is a flexible printed circuit board having flexibility, and a magnetic sensor 6 (a first magnetic sensor 6A), a first connector CN1, and a second connector CN2 are mounted thereon.

Specifically, as illustrated in FIG. 3, the first circuit board 10A is connected to the outer circuit board 11 via the first connector CN1 at the outer (the Y2 side) of the connector portion 10C. As illustrated in FIG. 6B, the first circuit board 10A is configured in such a manner that the inner surface (the Y1 side) of the piezoelectric device fixing portion 10P is bonded to the first piezoelectric device 8A with an anisotropic conductive adhesive, an anisotropic conductive adhesive film, or the like.

The second piezoelectric device 8B has the same configuration as the first piezoelectric device 8A. Specifically, the second piezoelectric device 8B extends in the Z-axis direction and is configured to be able to realize bending vibration (circular motion) having two nodes ND. In other words, when the bending vibration is performed, the two nodes ND hardly vibrate. The second piezoelectric device 8B has a two-layer structure stacked in the Y-axis direction, which is constituted by a first layer that realizes first bending vibration on the XZ plane and a second layer that realizes second bending vibration on the YZ plane. The second piezoelectric driver PD2 can bend and vibrate (circularly move) the second piezoelectric device 8B so that the orbit drawn by the midpoint of the second piezoelectric device 8B becomes a circular orbit around the second rotation axis 8BX in a top view when an application of a voltage to the piezoelectric devices constituting the first layer and an application of a voltage to the piezoelectric devices constituting the second layer are individually performed at appropriate timings. In other words, the second piezoelectric device 8B can realize a motion (circular motion) in which the midpoint thereof draws a circle. In the example illustrated in FIG. 6B, the second rotation axis 8BX is parallel to the Z axis. In addition, the second piezoelectric driver PD2 can switch the movement direction (rotation direction) of the midpoint that follows the circular orbit between the clockwise direction and the counterclockwise direction when viewed from the Z1 side by applying a voltage at an appropriate timing. This switching of the rotation direction allows the second piezoelectric driver PD2 to switch the movement direction of the second lens holder 3B along the optical axis direction. The circle (circular orbit) drawn by the midpoint of the second piezoelectric device 8B is not required to be a perfect circle, and may be a substantially circular shape.

The arrow drawn around the second piezoelectric device 8B in FIG. 6B represents bending vibration of the second piezoelectric device 8B (a circular motion in which the second piezoelectric device 8B rotates in the clockwise direction as viewed from the Z1 side around the second rotation axis 8BX while being bent). In this case, the second piezoelectric driver PD2 including the second contact member 9B in contact with the second receiving member RV2 (the movable-side shaft member 7) moves forward (in the X1 direction). Although not indicated by an arrow, the second piezoelectric device 8B can also rotate in the counterclockwise direction as viewed from the Z1 side around the second rotation axis 8BX while being bent. In this case, the second piezoelectric driver PD2 including the second contact member 9B in contact with the second receiving member RV2 (the movable-side shaft member 7) moves rearward (in the X2 direction).

In other words, the second lens holder 3B to which the second piezoelectric driver PD2 is attached is moved forward (in the X1 direction) when the rotation direction of the midpoint of the second piezoelectric device 8B is clockwise in a front view, and is moved rearward (in the X2 direction) when the rotation direction of the midpoint of the second piezoelectric device 8B is counterclockwise. In the illustrated example, the midpoint of the second piezoelectric device 8B is a point where the first bending vibration has a maximum magnitude (a point corresponding to an antinode of the first bending vibration) and a point where the second bending vibration has a maximum magnitude (a point corresponding to an antinode of the second bending vibration).

The second contact member 9B is attached to the second piezoelectric device 8B and is configured to be in contact with the second receiving member RV2 (the movable-side shaft member 7). In the illustrated example, the second contact member 9B is bonded to the inner surface of the second piezoelectric device 8B with an adhesive so as to cover the entire inner surface (the Y1 side which is a side facing the optical axis OA) of the second piezoelectric device 8B. The second contact member 9B is formed of a metal such as stainless steel, and is configured to have an appropriate thickness so as to be able to perform bending vibration (circular motion) in response to bending vibration (circular motion) of the second piezoelectric device 8B. In the illustrated example, the second contact member 9B is a friction plate formed of stainless steel. The second contact member 9B extends in the Z-axis direction which is the same direction as the direction in which the second piezoelectric device 8B extends. The second contact member 9B is configured in such a manner that the inner surface (the surface on the Y1 side) of a central portion thereof comes into contact with the second receiving member RV2 (the movable-side shaft member 7). Specifically, the second contact member 9B is configured to come into contact with the second receiving member RV2 (the movable-side shaft member 7) at a portion where bending vibration (circular motion) has the maximum magnitude (a portion corresponding to an antinode of the bending vibration). In addition, the second contact member 9B has a surface on a side (the Y1 side) which comes into contact with the second receiving member RV2 (the movable-side shaft member 7), which is a convex curved surface which is convex to the Y1 side.

As long as the second contact member 9B comes into contact with the movable-side shaft member 7, a length dimension of the second contact member 9B in the Z-axis direction may differ from that of the second piezoelectric device 8B. In the illustrated example, the length dimension of the second contact member 9B in the Z-axis and that of the second piezoelectric device 8B are substantially the same.

The second circuit board 10B is a substrate including a conductive pattern, and is configured to be able to electrically connect an external power source and the second piezoelectric device 8B via the outer circuit board 11. In the illustrated example, the second circuit board 10B is a flexible printed substrate having flexibility, and includes a connector portion 10C, a piezoelectric device fixing portion 10P, a sensor fixing portion 10S, and a curved portion 10W.

Specifically, as illustrated in FIG. 3, the second circuit board 10B is connected to the outer circuit board 11 via the second connector CN2 at the outer side (the Y2 side) of the connector portion 10C. The second circuit board 10B is configured to be deformed (bent) in accordance with the movement of the second lens holder 3B in the optical axis direction, and to apply a voltage to the second piezoelectric device 8B while moving the position of the curved portion 10W. More specifically, the curved portion 10W moves rearward in accordance with the rearward (the X2-direction) movement of the second lens holder 3B, and moves forward in accordance with the forward (the X1-direction) movement of the second lens holder 3B.

As illustrated in FIG. 6B, the second circuit board 10B is configured in such a manner that the inner (Y1-side) surface of the piezoelectric device fixing portion 10P is bonded to the second piezoelectric device 8B with an anisotropic conductive adhesive, an anisotropic conductive adhesive film, or the like. The second circuit board 10B is configured in such a manner that the sensor fixing portion 10S is positioned on the lower side (the Z2 side) of the second biasing member 13B. The second circuit board 10B is configured in such a manner that the magnetic sensor 6 (second magnetic sensor 6B) is mounted on the lower (Z2-side) surface of the sensor fixing portion 10S. In the illustrated example, the sensor fixing portion 10S has an upper (Z-side) surface fixed to a lower (Z2-side) surface of the second biasing member 13B with an adhesive.

The biasing member 13 is formed of a leaf spring member in the illustrated example. Specifically, as illustrated in FIG. 7, the first biasing member 13A includes a fixed portion 13F fixed to the fourth side plate portion 2A4 of the base member 2, a supporting portion 13S supporting the first piezoelectric driver PD1, and an elastically deformable portion 13E provided between the fixed portion 13F and the supporting portion 13S and capable of being elastically deformed. FIG. 7 is a perspective view of the first biasing member 13A attached to the base member 2. In FIG. 7, for the sake of clarity, the first biasing member 13A is illustrated in a dot pattern.

As illustrated in FIG. 7, the first biasing member 13A is fixed to the base member 2 via a fixed portion 13F so that the supporting portion 13S and the elastically deformable portion 13E do not contact the base member 2. Specifically, the fixed portion 13F provided at both ends of the elastically deformable portion 13E is attached to the fourth side plate portion 2A4 so as to be fitted into grooves 2G formed on the inner surface side of the fourth side plate portion 2A4 of the base member 2.

More specifically, the fixed portion 13F of the first biasing member 13A includes a front fixed portion 13FF and a rear fixed portion 13FB (see FIG. 6B), and the supporting portion 13S includes an upper supporting portion 13SU and a lower supporting portion 13SD. The elastically deformable portion 13E includes an upper elastically deformable portion 13EU and a lower elastically deformable portion 13ED provided between the front fixed portion 13FF and the rear fixed portion 13FB. The front fixed portion 13FF and the rear fixed portion 13FB have the same shape and the same size; the upper supporting portion 13SU and the lower supporting portion 13SD have the same shape and the same size; and the upper elastically deformable portion 13EU and the lower elastically deformable portion 13ED have the same shape and the same size. In other words, the first biasing member 13A is configured to be plane-symmetrical with respect to a symmetrical plane (a plane that divides the first biasing member 13A into two in the front and rear direction) parallel to the YZ plane. The first biasing member 13A is also configured to be plane-symmetrical with respect to a symmetrical plane (a plane that divides the first biasing member 13A into two in the vertical direction) parallel to the XY plane.

The supporting portion 13S of the first biasing member 13A is configured to be bent in an L shape from the elastically deformable portion 13E and to protrude to the side (the Y1 side) where the first lens holder 3A is located. A recessed portion RS (see FIG. 6B) is formed at the tip of the supporting portion 13S. The recessed portion RS is a recess that is open on the side where the first lens holder 3A is located (the Y1 side). Specifically, the recessed portion RS is formed in the distal end of each of the upper supporting portion 13SU and the lower supporting portion 13SD so as to have the same shape and the same size. As illustrated in FIG. 6A, the first piezoelectric driver PD1 is partially arranged in the recessed portions RS and is fixed to the supporting portion 13S with an adhesive in a state of being in contact with inner edge portions BE (see FIG. 6B) of the recessed portions RS.

More specifically, as illustrated in FIG. 6B, each of the recessed portions RS has a front edge portion and a rear edge portion which face each other, with the inner edge portion BE interposed therebetween. As illustrated in FIG. 6A, the first piezoelectric driver PD1 is arranged between the front edge portions and the rear edge portions.

The positions where the inner edge portions BE of the recessed portions RS and the first piezoelectric driver PD1 are in contact with each other correspond to the positions of the nodes ND of the first piezoelectric device 8A that realize bending vibration (circular motion). The positions of the nodes ND include a position of a first node ND1 and a position of a second node ND2. In FIG. 6B, for the sake of clarity, the positions of the nodes ND are illustrated with a cross pattern.

The positions at which the inner edge portions BE of the recessed portions RS and the first piezoelectric driver PD1 are in contact with each other (the position of the node ND) correspond to a position at a predetermined distance from the end portion of the first piezoelectric driver PD1 in the Z-axis direction. The predetermined distance is, for example, a distance of approximately one quarter of the entire length of the piezoelectric driver PD.

The first piezoelectric driver PD1 and the supporting portion 13S are fixed to each other by an adhesive. Specifically, the first piezoelectric driver PD1 (the first circuit board 10A) and the supporting portion 13S of the first biasing member 13A are fixed to each other by an adhesive at the inner edge portions BE of the recessed portions RS. In the illustrated example, the adhesive is an ultraviolet curable adhesive. However, the adhesive may be another type of adhesive, such as a moisture-curable adhesive or a thermosetting adhesive.

As illustrated in FIG. 6B, the elastically deformable portion 13E of the first biasing member 13A has a portion extending forward (in the X1 direction) from the supporting portion 13S and a portion extending rearward (in the X2 direction) from the supporting portion 13S. Specifically, the upper elastically deformable portion 13EU has a portion extending forward from the upper supporting portion 13SU and a portion extending rearward from the upper supporting portion 13SU, and the lower elastically deformable portion 13ED has a portion extending forward from the lower supporting portion 13SD and a portion extending rearward from the lower supporting portion 13SD. The direction in which the elastically deformable portion 13E extends is along the optical axis direction.

As illustrated in FIG. 5C, the second biasing member 13B is fixed to the right end of the second right shaft receiving portion 32BR of the second lens holder 3B (the end portion on the Y2 side) via the fixed portion 13F so that the supporting portion 13S and the elastically deformable portion 13E do not contact the second lens holder 3B.

Specifically, the fixed portion 13F of the second biasing member 13B includes an upper fixed portion 13FU and a lower fixed portion 13FD as illustrated in FIG. 6B, and the supporting portion 13S includes an upper supporting portion 13SU and a lower supporting portion 13SD. The elastically deformable portion 13E includes a front elastically deformable portion 13EF and a rear elastically deformable portion 13EB provided between the fixed portion 13F and the supporting portion 13S. The upper fixed portion 13FU and the lower fixed portion 13FD have the same shape and the same size, the upper supporting portion 13SU and the lower supporting portion 13SD have the same shape and the same size, and the front elastically deformable portion 13EF and the rear elastically deformable portion 13EB have the same shape and the same size. In other words, the second biasing member 13B is configured to be plane-symmetrical with respect to a symmetrical plane (a plane that divides the second biasing member 13B into two in the front and rear direction) parallel to the YZ plane. The second biasing member 13B is configured to be plane-symmetrical with respect to a symmetrical plane (a plane that divides the second biasing member 13B into two in the vertical direction) parallel to the XY plane.

The supporting portion 13S of the second biasing member 13B is configured to be bent in an L shape from the elastically deformable portion 13E and to protrude to the side (the Y1 side) where the second lens holder 3B is located. The recessed portions RS (see FIG. 6B) are formed at the respective tips of the supporting portion 13S. The recessed portion RS is a recess that is open on the side where the second lens holder 3B is located (the Y1 side). Specifically, the recessed portion RS is formed in the distal end of each of the upper supporting portion 13SU and the lower supporting portion 13SD so as to have the same shape and the same size. As illustrated in FIG. 6A, the second piezoelectric driver PD2 is partially arranged in the recessed portions RS and is fixed to the supporting portion 13S with an adhesive in a state of being in contact with inner edge portions BE (see FIG. 6B) of the recessed portions RS.

More specifically, as illustrated in FIG. 6B, each of the recessed portions RS has a front edge portion and a rear edge portion which face each other, with the inner edge portion BE interposed therebetween. As illustrated in FIG. 6A, the second piezoelectric driver PD2 is arranged between the front edge portions and the rear edge portions.

The positions where the inner edge portions BE of the recessed portions RS and the second piezoelectric driver PD2 are in contact with each other correspond to the positions of the nodes ND of the second piezoelectric device 8B that realizes bending vibration (circular motion). The positions of the nodes ND include a position of a third node ND3 and a position of a fourth node ND4. In FIG. 6B, for the sake of clarity, the positions of the nodes ND are illustrated with a cross pattern.

The positions at which the inner edge portions BE of the recessed portions RS and the second piezoelectric driver PD2 are in contact with each other (the position of the node ND) correspond to a position at a predetermined distance from the end portion of the second piezoelectric driver PD2 in the Z-axis direction. The predetermined distance is, for example, a distance of approximately one quarter of the entire length of the piezoelectric driver PD. The second piezoelectric driver PD2 and the supporting portion 13S are fixed to each other by an adhesive. Specifically, the second piezoelectric driver PD2 (the second circuit board 10B) and the supporting portion 13S (the second biasing member 13B) are fixed to each other by an adhesive at the inner edge portions BE of the recessed portions RS. In the illustrated example, the adhesive is an ultraviolet curable adhesive. However, the adhesive may be another type of adhesive, such as a moisture-curable adhesive or a thermosetting adhesive.

As illustrated in FIG. 6B, the elastically deformable portion 13E of the second biasing member 13B has a front elastically deformable portion 13EF extending forward (in the X1 direction) from the supporting portion 13S and a rear elastically deformable portion 13EB extending rearward (in the X2 direction) from the supporting portion 13S. The elastically deformable portion 13E includes a portion extending along the optical axis direction.

The fixing portions 13F are respectively provided at both ends of the elastically deformable portion 13E. As illustrated in FIGS. 4 and 5C, the fixed portion 13F is attached so as to sandwich the upper end portion and the lower end portion of the second right shaft receiving portion 32BR of the second lens holder 3B.

In the illustrated example, the fixed portion 13F of the second biasing member 13B includes the upper fixed portion 13FU and the lower fixed portion 13FD. The second biasing member 13B is configured to be able to sandwich the right end portion of the second right shaft receiving portion 32BR of the second lens holder 3B between the upper fixed portion 13FU and the lower fixed portion 13FD. The second biasing member 13B may be fixed to the second right shaft receiving portion 32BR by an adhesive or may be reinforced by an adhesive.

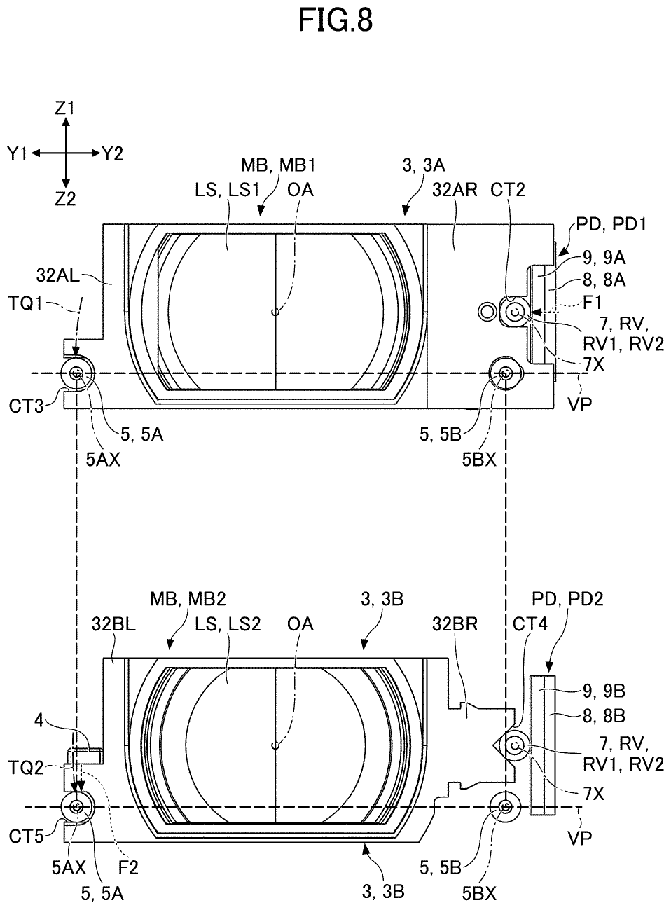

Next, the first movable-side member MB1 will be described with reference to FIG. 8. FIG. 8 is a front view of the lens holder 3. Specifically, the top diagram of FIG. 8 is a front view of the first lens holder 3A guided by the shaft member 5, and the bottom drawing of FIG. 8 is a front view of the second lens holder 3B guided by the shaft members (the first shaft member 5A and the movable-side shaft member 7).

The shaft member 5 includes the first shaft member 5A and the second shaft member 5B. As illustrated in the top drawing of FIG. 8, the movable-side shaft member 7 as the receiving member RV is provided at a position away from a virtual plane VP. In particular, the movable-side shaft member 7 is provided at a position where the axis 7X thereof is not on the virtual plane VP. In the illustrated example, the movable-side shaft member 7 is configured in such a manner that the axis 7X and the virtual plane VP are parallel to each other. The virtual plane VP is a virtual plane including the axial line of the first shaft member 5A (the first axis 5AX) and the axial line of the second shaft member 5B (the second axis 5BX) which are parallel to each other. In the illustrated example, the movable-side shaft member 7 is provided at a position offset to the upper side (the Z1 side) from the virtual plane VP. However, the movable-side shaft member 7 may be provided at a position offset to the lower side (the Z2 side) from the virtual plane VP. The movable-side shaft member 7 (the axis 7X) is configured to be parallel to the first shaft member 5A (the first axis 5AX).

This configuration provides an effect of suppressing looseness of the first lens holder 3A. In the illustrated example, the force with which the first biasing member 13A biases the first receiving member RV1 (the movable-side shaft member 7) attached to the first lens holder 3A toward the Y1 side (the force F1 indicated by a dot line arrow) causes torque (the torque TQ1 indicated by a dot-chain line arrow) that rotates the first lens holder 3A about the axial line (the second axis 5BX) of the second shaft member 5B. The torque TQ1 acts so as to press the first left shaft receiving portion 32AL of the first lens holder 3A against the first shaft member 5A from above. In addition to the torque TQ1, a torque (self-weight torque) that causes the self-weight of the first lens holder 3A to rotate the first lens holder 3A around the axial line (the second axis 5BX) of the second shaft member 5B acts on the first lens holder 3A. The first biasing member 13A is configured in such a manner that the magnitude of the torque TQ1 generated by the force F1 is larger than the magnitude of the self-weight torque. Therefore, regardless of a posture that the lens holder driving device 101 takes (even an upside-down posture), the combined torque obtained by combining the torque TQ1 and the self-weight torque always acts on the first lens holder 3A such that the first left shaft receiving portion 32AL of the first lens holder 3A is pressed against the first shaft member 5A. In other words, not only in the case where the torque TQ1 and the self-weight torque are in the same direction, but also in the case where the torque TQ1 and the self-weight torque are in opposite directions, the combined torque always acts on the first lens holder 3A such that the first left shaft receiving portion 32AL of the first lens holder 3A is pressed against the first shaft member 5A. As a result, regardless of a posture of the lens holder driving device 101 (even an upside-down posture), the first left shaft receiving portion 32AL of the first lens holder 3A and the first shaft member 5A are always in contact with each other, and an occurrence of looseness between the first left shaft receiving portion 32AL and the first shaft member 5A is suppressed. The same applies to the looseness between the first right shaft receiving portion 32AR of the first lens holder 3A and the second shaft member 5B.

As illustrated in the bottom drawing of FIG. 8, the magnet 4 is provided at a position away from the virtual plane VP. Specifically, the magnet 4 is provided at a position that is not on the virtual plane VP. In the illustrated example, the magnet 4 is provided at a position offset to the upper side (the Z1 side) from the virtual plane VP. However, the magnet 4 may be provided at a position offset to the lower side (the Z2 side) from the virtual plane VP.

This configuration provides an effect of suppressing looseness of the second lens holder 3B. In the illustrated example, a magnetic attraction force (the force F2 indicated by a dot-line arrow) acting between the magnet 4 and the first shaft member 5A produces a torque (the torque TQ2 indicated by the dot-chain line arrow) that causes the second lens holder 3B to rotate about the axial line (the axis 7X) of the movable-side shaft member 7. The torque TQ2 acts on the second lens holder 3B such that the second left shaft receiving portion 32BL is pressed against the first shaft member 5A from above. In addition to the torque TQ2, a torque (self-weight torque) that causes the self-weight of the second lens holder 3B to rotate the second lens holder 3B around the axial line (the axis 7X) of the movable-side shaft member 7 acts on the second lens holder 3B. The magnet 4 is configured in such a manner that the magnitude of the torque TO2 generated by the force F2 is larger than the magnitude of the self-weight torque. Therefore, regardless of a posture that the lens holder driving device 101 takes (even an upside-down posture), the combined torque obtained by combining the torque TQ2 and the self-weight torque always acts on the second lens holder 3B such that the second left shaft receiving portion 32BL of the second lens holder 3B is pressed against the first shaft member 5A. In other words, not only in the case where the torque TQ2 and the self-weight torque are in the same direction, but also in the case where the torque TQ2 and the self-weight torque are in opposite directions, the combined torque always acts on the second lens holder 3B such that the second left shaft receiving portion 32BL of the second lens holder 3B is pressed against the first shaft member 5A. As a result, regardless of a posture of the lens holder driving device 101 (even an upside-down posture), the second left shaft receiving portion 32BL of the second lens holder 3B and the first shaft member 5A are always in contact with each other, and an occurrence of looseness between the second left shaft receiving portion 32BL and the first shaft member 5A is suppressed.

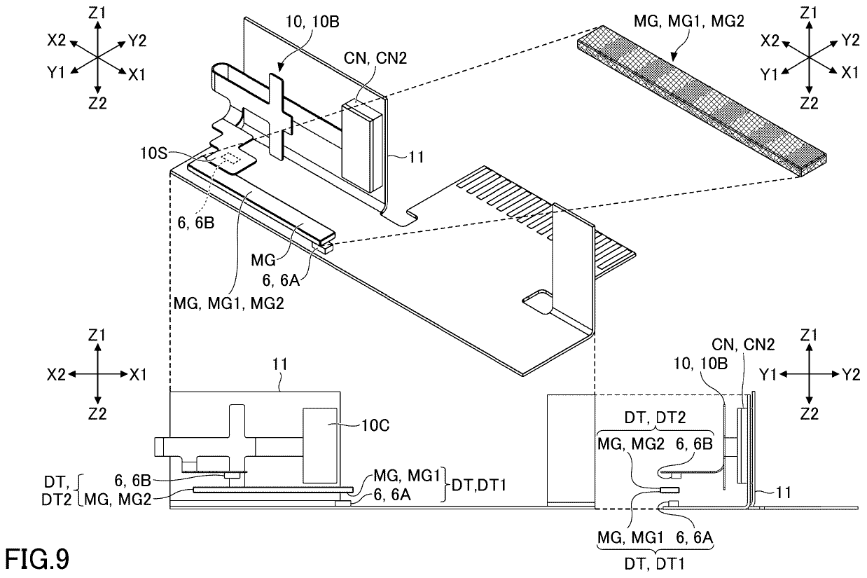

Next, the position detection mechanism DT will be described with reference to FIG. 9. FIG. 9 is a diagram illustrating an example of a positional relationship between the magnetic sensor 6, the magnetic field generating member MG, the second circuit board 10B, and the outer circuit board 11. In detail, the top left diagram of FIG. 9 is a perspective view of the magnetic sensor 6, the magnetic field generating member MG, the second circuit board 10B, and the outer circuit board 11, the top right diagram of FIG. 9 is an enlarged perspective view of the magnetic field generating member MG, the bottom left diagram of FIG. 9 is a left side view of the magnetic sensor 6, the magnetic field generating member MG, the second circuit board 10B, and the outer circuit board 11, and the bottom right diagram of FIG. 9 is a front view of the magnetic sensor 6, the magnetic field generating member MG, the second circuit board 10B, and the outer circuit board 11.

The position detection mechanism DT is a mechanism for detecting a position of the lens holder 3, and includes the magnetic sensor 6 and the magnetic field generating member MG.

The magnetic field generating member MG is a member configured to be able to generate a magnetic field, and is a permanent magnet, an electromagnet, or the like. In the illustrated example, the magnetic field generating member MG is a permanent magnet whose both surfaces are multi-pole magnetized, and is fixed to the first right shaft receiving portion 32AR of the first lens holder 3A. In the top right diagram of FIG. 9, for easy understanding of the description, a cross pattern is given to the N-pole portion of the magnetic field generating member MG, and a dot pattern is given to the S-pole portion of the magnetic field generating member MG.

The magnetic sensor 6 is configured to be able to detect a magnetic field generated by the magnetic field generating member MG. In the illustrated example, the magnetic sensor 6 is configured by a giant magneto resistive effect (GMR) element, and is configured to measure a voltage value that changes in accordance with the magnitude of the magnetic field generated by the magnetic field generating member MG and received by the magnetic sensor 6, and output the measured voltage value to the drive circuit. The drive circuit is configured to be able to detect a position of the lens holder 3 to which the magnetic sensor 6 or the magnetic field generating member MG is attached, based on the output of the magnetic sensor 6. The magnetic sensor 6 is configured to output a larger voltage value as the N-pole portion approaches, and to output a smaller voltage value as the S-pole portion approaches. The magnetic sensor 6 may be configured to output a smaller voltage value as the N-pole portion approaches, and to output a larger voltage value as the S-pole portion approaches. The magnetic sensor 6 may be configured to detect a position of the lens holder 3 by using another magnetoresistive element, such as a semiconductor magnetoresistive (SMR) element, an anisotropic magnetoresistive (AMR) element, or a tunnel magnetoresistive (TMR) element, or may be configured to detect a position of the lens holder 3 by using a Hall element or the like.

In the illustrated example, the position detection mechanism DT includes a first position detection mechanism DT1 that detects a position of the first lens holder 3A and a second position detection mechanism DT2 that detects a position of the second lens holder 3B. The magnetic sensor 6 includes a first magnetic sensor 6A attached to the outer circuit board 11 and a second magnetic sensor 6B attached to the sensor fixing portion 10S of the second circuit board 10B. The magnetic field generating member MG is configured in such a manner that the lower half thereof functions as a first magnetic field generating member MG1 corresponding to the first magnetic sensor 6A, and the upper half thereof functions as a second magnetic field generating member MG2 corresponding to the second magnetic sensor 6B. The first position detection mechanism DT1 includes the first magnetic sensor 6A and the first magnetic field generating member MG1, and the second position detection mechanism DT2 includes the second magnetic sensor 6B and the second magnetic field generating member MG2. The first magnetic field generating member MG1 and the second position detection mechanism DT2 may be separate and independent members.

When the first movable-side member MB1 moves along the optical axis direction, the first magnetic field generating member MG1 fixed to the first right shaft receiving portion 32AR of the first lens holder 3A moves relative to the first magnetic sensor 6A fixed to the base member 2 (the outer circuit board 11).

The drive circuit acquires a voltage value that is output by the first magnetic sensor 6A at each predetermined control cycle, and derives a relative position of the first lens holder 3A with respect to the base member 2 as a current position of the first lens holder 3A based on a transition of the voltage value. The drive circuit can move the first lens holder 3A to a desired position by controlling a voltage applied to the first piezoelectric device 8A of the first piezoelectric driver PD1 while checking the current position of the first lens holder 3A.

Similarly, when the second movable-side member MB2 moves relative to the first lens holder 3A along the optical axis direction, the second magnetic sensor 6B fixed to the sensor fixing portion 10S of the second circuit board 10B moves relative to the second magnetic field generating member MG2 fixed to the first right shaft receiving portion 32AR of the first lens holder 3A.

The drive circuit acquires a voltage value that is output by the second magnetic sensor 6B at each predetermined control cycle, and derives a relative position of the second lens holder 3B with respect to the first lens holder 3A as a current position of the second lens holder 3B based on a transition of the voltage value. The drive circuit can move the second lens holder 3B to a desired position by controlling a voltage applied to the second piezoelectric device 8B of the second piezoelectric driver PD2 while checking the current position of the second lens holder 3B.

With this configuration, the lens holder driving device 101 can integrally move the first lens body LS1 and the second lens body LS2 in the optical axis direction by the first piezoelectric driver PD1. In addition, the lens holder driving device 101 can relatively move the second lens body LS2 in the optical axis direction with respect to the first lens body LS1 by the second piezoelectric driver PD2. Therefore, the lens holder driving device 101 can increase and decrease the distance between the first lens body LS1 and the second lens body LS2 while moving the first lens body LS1 and the second lens body LS2 in the same direction at substantially the same speed.

As described above, the lens holder driving device 101 according to the embodiment of the present invention includes, as illustrated in FIG. 3, the fixed-side member FB; the first lens holder 3A capable of holding the first lens body LS1; the second lens holder 3B capable of holding the second lens body LS2 arranged in such a manner that the second lens holder 3B has the same optical axis as the first lens body LS1; the shaft member for guiding each of the first lens holder 3A and the second lens holder 3B movably in the optical axis direction; the first movable-side member MB1 including the first lens holder 3A; the second movable-side member MB2 including the second lens holder 3B; the first piezoelectric driver PD1 having the first piezoelectric device 8A and configured to move the first movable-side member MB1 through a movement of the first piezoelectric device 8A in the optical axis direction; and the second piezoelectric driver PD2 having the second piezoelectric device 8B and configured to move the second movable-side member MB2 through a movement of the second piezoelectric device 8B in the optical axis direction. The second movable-side member MB2 is included in the first movable-side member MB1 and is movable in the optical axis direction with respect to the first lens holder 3A. In other words, the second movable-side member MB2 is a part of the first movable-side member MB1, and is moved in the optical axis direction by not only the second piezoelectric driver PD2 but also the first piezoelectric driver PD1. The first piezoelectric driver PD1 is provided in the fixed-side member FB or the first lens holder 3A so that the second lens holder 3B can move in the optical axis direction together with the first lens holder 3A with respect to the fixed-side member FB. The second piezoelectric driver PD2 is provided in the second movable-side member MB2 or the first lens holder 3A so that the second lens holder 3B is movable in the optical axis direction with respect to the first lens holder 3A.

With this configuration, the lens holder driving device 101 can move the first lens holder 3A and the second lens holder 3B together (simultaneously) in the optical axis direction. For example, the lens holder driving device 101 can move the first lens body LS1 (a zoom lens) and the second lens body LS2 (a focus lens) in a state where the distance between the first lens body LS1 (a zoom lens) and the second lens body LS2 (a focus lens) is maintained, that is, in a focused state, during zoom-in or zoom-out. Therefore, the lens holder driving device 101 can shorten the time required for focusing after zoom-in or zoom-out. In addition, the lens holder driving device 101 can move the second lens body LS2 (a focus lens) alone without moving the first lens body LS1 (a zoom lens) in a predetermined case such as a case where the object length is slightly changed.

In the example illustrated in FIG. 3, the first piezoelectric driver PD1 is provided in the fixed-side member FB (the base member 2). Specifically, the first movable-side member MB1 includes the first receiving member RV1 that extends in the optical axis direction and receives a motion (a force generated by a motion) of the first piezoelectric driver PD1. The first piezoelectric driver PD1 is biased toward the first receiving member RV1 by the first biasing member 13A provided in the fixed-side member FB (the base member 2). This mechanism brings about an effect that the configuration of the lens holder driving device 101 can be simplified.

The fixed-side member FB may include the shaft member 5 (the first shaft member 5A and the second shaft member 5B) extending in the optical axis direction and configured to guide the first movable-side member MB1 movably in the optical axis direction. In this case, as illustrated in FIG. 8, the first receiving member RV1 may be provided at a position shifted from the virtual plane VP passing through the center of each of the first shaft member 5A and the second shaft member 5B.

With this configuration, the lens holder driving device 101 can suppress the looseness of the first lens holder 3A when the first lens holder 3A is moved in the optical axis direction. This is because the lens holder driving device 101 can continuously press the first lens holder 3A against the shaft member 5 by continuously pressing the first piezoelectric driver PD1 against the first receiving member RV1 by the first biasing member 13A.

In the illustrated example, the second piezoelectric driver PD2 is provided in the second movable-side member MB2 (the second lens holder 3B). In this case, as illustrated in FIG. 4, the first lens holder 3A may include the second receiving member RV2 that extends in the optical axis direction and receives a motion (a force generated by a motion) of the second piezoelectric driver PD2. The second piezoelectric driver PD2 may be biased toward the second receiving member RV2 by the second biasing member 13B provided in the second movable-side member MB2 (the second lens holder 3B). This mechanism provides an effect that the configuration of the lens holder driving device 101 can be simplified because both the first receiving member RV1 and the second receiving member RV2 are provided in the first lens holder 3A.

The first receiving member RV1 and the second receiving member RV2 may be configured by the same shaft member (the movable-side shaft member 7) as illustrated in FIG. 3. In other words, the movable-side shaft member 7 may be used as both the first receiving member RV1 and the second receiving member RV2.

This configuration provides an effect of reducing the number of components. This configuration also provides an effect of achieving a reduction in the size of the lens holder driving device 101. However, the first receiving member RV1 and the second receiving member RV2 may be configured by two independent shaft members.

The fixed-side member FB may include, as described above, the shaft member 5 (the first shaft member 5A and the second shaft member 5B) extending in the optical axis direction and configured to guide the first movable-side member MB1 movably in the optical axis direction. In this case, the second movable-side member MB2 (the second lens holder 3B) may be guided to be movable in the optical axis direction with respect to the first movable-side member MB1 (the first lens holder 3A) by one of the first shaft member 5A and the second shaft member 5B and another shaft member (the movable-side shaft member 7). In the example illustrated in the bottom drawing of FIG. 8, the second movable-side member MB2 (the second lens holder 3B) is guided by the first shaft member 5A and the movable-side shaft member 7 movably in the optical axis direction with respect to the first lens holder 3A.

In this configuration, since the movement of the second movable-side member MB2 is guided by the two shaft members, this configuration provides an effect that the second movable-side member MB2 is appropriately guided. This is because guiding the movement of the second movable-side member MB2 by the three shaft members would hinder the movement of the second movable-side member MB2. Further, this configuration is realized by three shaft members (the first shaft member 5A, the second shaft member 5B, and the movable-side shaft member 7) in total, and therefore, there is an effect that the configuration of the lens holder driving device 101 can be simplified. Further, this configuration is realized by the three shaft members in total, and therefore, there is an effect that the lens holder driving device 101 can be miniaturized.

One of the first shaft member 5A and the second shaft member 5B may be arranged at a position facing the other of the first shaft member 5A and the second shaft member 5B and another shaft member (the movable-side shaft member 7) with the second lens body LS2 interposed therebetween. In the example illustrated in the bottom drawing of FIG. 8, the first shaft member 5A is arranged at a position facing each of the second shaft member 5B and the movable-side shaft member 7 with the second lens body LS2 interposed therebetween.

This configuration provides an effect that the movement of each of the first lens holder 3A and the second lens holder 3B in the optical axis direction can be appropriately guided. This is because the distance between the two shaft members used for guiding can be increased.

At least one of the first shaft member 5A and the second shaft member 5B that guide the movement of the second movable-side member MB2 and another shaft member (the movable-side shaft member 7) may be a magnetic metallic member. The magnet 4 may be provided on the second movable-side member MB2. In this case, the magnet 4 and the magnetic metal member may be arranged in such a manner that an attractive force acts between the magnet 4 and the magnetic metal member. In the example illustrated in the bottom diagram of FIG. 8, the first shaft member 5A is a magnetic metallic member, and the magnet 4 and the first shaft member 5A are arranged in such a manner that an attraction force acts between the magnet 4 and the first shaft member 5A.

This configuration provides an effect of suppressing the occurrence of looseness of the second movable-side member MB2 when the second movable-side member MB2 moves along the optical axis direction.

Further, one of the first shaft member 5A and the second shaft member 5B may be a magnetic metallic member. In this case, the magnet 4 may be provided on the opposite side of the second lens body LS2 from the second piezoelectric driver PD2. In the example illustrated in the bottom drawing of FIG. 8, the first shaft member 5A is a magnetic metallic member, and the magnet 4 is provided on the opposite side of the second piezoelectric driver PD2 with the second lens body LS2 interposed therebetween.

This configuration can improve the assemblability of the lens holder driving device 101. This is because, in this configuration, the second piezoelectric driver PD2 and the magnet 4 are arranged to be separated from each other, and thus the assembly of the second piezoelectric driver PD2 and the magnet 4 to the second movable-side member MB2 does not become complicated.

The first movable-side member MB1 (the first lens holder 3A) may be provided with the magnetic field generating member MG. In this case, the fixed-side member FB may be provided with the first magnetic sensor 6A for detecting the magnetic field of the magnetic field generating member MG, and the second movable-side member MB2 may be provided with the second magnetic sensor 6B for detecting the magnetic field of the magnetic field generating member MG.

In this configuration, the magnetic field generating member MG is shared by the first magnetic sensor 6A for detecting the relative position of the first lens holder 3A with respect to the base member 2 and the second magnetic sensor 6B for detecting the relative position of the second movable-side member MB2 (the second lens holder 3B) with respect to the first lens holder 3A. Therefore, this configuration brings about an effect that the configuration of the lens holder driving device 101 can be simplified. Further, this configuration provides an effect of reducing the number of components.

The preferred embodiments of the present invention have been described in detail above. However, the present invention is not limited to the above-described embodiments. Various modifications and substitutions may be applied to the above-described embodiment without departing from the scope of the present invention. Further, the features described with reference to the embodiments may be appropriately combined as long as there is no technical contradiction.

For example, in the above embodiment, the portions (the first through hole TH1, the first cutout grooves CT1, the third cutout groove CT3, and the fifth cutout groove CT5) functioning as the guided portions guided by the shaft member 5 (the first shaft member 5A and the second shaft member 5B) when the lens holder 3 moves in the optical axis direction are provided in the first lens holder 3A and the second lens holder 3B; however, the portions functioning as the guided portions may be provided in the first lens body LS1 and the second lens body LS2.

What is claimed is:

1. A lens holder driving device, comprising:
a fixed-side member;
a first lens holder configured to hold a first lens body;
a second lens holder configured to hold a second lens body arranged in such a manner that the second lens body has a same optical axis as the first lens body;
a first movable-side member including the first lens holder;
a second movable-side member including the second lens holder;
a first piezoelectric driver configured to include a first piezoelectric device and move the first movable-side member in a direction of the optical axis by a motion of the first piezoelectric device; and
a second piezoelectric driver configured to include a second piezoelectric device and move the second movable-side member in the direction of the optical axis by a motion of the second piezoelectric device, wherein
the second movable-side member is included in the first movable-side member and is movable in the direction of the optical axis with respect to the first lens holder,
the first piezoelectric driver is provided in the fixed-side member or the first lens holder, and
the second piezoelectric driver is provided in the second movable-side member or the first lens holder.

2. The lens holder driving device according to claim 1, wherein
the first piezoelectric driver is provided in the fixed-side member, and
the first movable-side member includes a first receiving member that extends in the direction of the optical axis and receives a motion of the first piezoelectric driver, and
the first piezoelectric driver is biased toward the first receiving member by a first biasing member provided in the fixed-side member.

3. The lens holder driving device according to claim 2, wherein
the fixed-side member includes a first shaft member and a second shaft member extending in the direction of the optical axis and configured to guide the first movable-side member to be movable in the direction of the optical axis, and
the first receiving member is provided at a position shifted from a virtual plane passing through a center of each of the first shaft member and the second shaft member.

4. The lens holder driving device according to claim 2, wherein
the second piezoelectric driver is provided in the second movable-side member,
the first lens holder includes a second receiving member that extends in the direction of the optical axis and receives a motion of the second piezoelectric driver, and
the second piezoelectric driver is biased toward the second receiving member by a second biasing member provided in the second movable-side member.

5. The lens holder driving device according to claim 4, wherein
the first receiving member and the second receiving member are configured by a same shaft member, the same shaft member being a shaft member.

6. The lens holder driving device according to claim 5, wherein
the fixed-side member includes a first shaft member and a second shaft member extending in the direction of the optical axis and configured to guide the first movable-side member to be movable in the direction of the optical axis, and
the second movable-side member is guided by one of the first shaft member or the second shaft member and by the shaft member movably in the direction of the optical axis with respect to the first lens holder.

7. The lens holder driving device according to claim 6, wherein
one of the first shaft member and the second shaft member is arranged at a position facing an other of the first shaft member and the second shaft member and the shaft member, with the second lens body interposed therebetween.

8. The lens holder driving device according to claim 6, wherein
at least one of the shaft member or one of the first shaft member and the second shaft member that guide the movement of the second movable-side member is a magnetic metal member, and
the second movable-side member is provided with a magnet, and
an attractive force acts between the magnet and the magnetic metal member.

9. The lens holder driving device according to claim 8, wherein
one of the first shaft member and the second shaft member is the magnetic metal member, and
the magnet is provided in a side opposite to the second piezoelectric driver with the second lens body interposed therebetween.

10. The lens holder driving device according to claim 1, wherein
the first movable-side member is provided with a magnetic field generating member, and
the fixed-side member is provided with a first magnetic sensor that detects a magnetic field of the magnetic field generating member, and
the second movable-side member is provided with a second magnetic sensor that detects a magnetic field of the magnetic field generating member.
